(19) United States
(12) Patent Application Publication
(10) Pub. No.: US 2026/0252976 A1
(43) Pub. Date: Aug. 27, 2026

(54) CONTEXTUAL CONFIRMATION CARDS

(71) Applicant: Uber Technologies, Inc., San Francisco, CA (US)

(72) Inventor: Reed Sierra Horton, San Francisco, CA (US)

(21) Appl. No.: 19/179,833

(22) Filed: Apr. 15, 2025

Related U.S. Application Data
(60) Provisional application No. 63/762,603, filed on Feb. 24, 2025.

(51) Int. Cl. G06Q 10/02; G06Q 50/47; G06F 3/04817; G06F 3/04842

(52) U.S. Cl. CPC G06Q 10/02; G06Q 50/47; G06F 3/04817; G06F 3/04842

(57) ABSTRACT

Systems and methods for providing contextual confirmation cards are provided. The system receives a transportation service request from a user and determines a match of the transportation service request to a transportation service that has one or more characteristics. Based in part on the one or more characteristics, the system determines a probability that the user will reject the transportation service, and based in part on the probability, determines content to present to the user. The content invites the user to consent to at least one of the characteristics. One or more graphical interfaces are presented on a device of the user and includes a request to accept the transportation service and a description of at least one of the characteristics. Responsive to an indication that the user has accepted the transportation service, the system causes a vehicle to begin executing the transportation service requested by the user.

### RELATED APPLICATION

This application claims priority to and the benefit of U.S. Provisional Patent Application Number 63/762,603, filed February 24, 2025, which is hereby incorporated by reference in its entirety.

### TECHNICAL FIELD

The present disclosure relates generally to transportation service provisioning and, more specifically, to dynamically determining content to provide in contextual confirmation cards for consent to the transportation service.

### BACKGROUND

When a user requests a transportation service, the user wants a transportation service request process to be simple and efficient. Oftentimes, the user is in a rush to arrive at their destination and does not want to have to navigate through multiple graphical interfaces or cards to request the transportation service. However, when a transportation service is different from what the user requested or expected, adequate information should be presented and consent received for the change in the transportation service. Yet, introducing too much information in too many graphical interfaces or cards can increase likelihood of rejection of the transportation service by the user. As such, a balance needs to be struck.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram illustrating a network environment suitable for providing transportation services by a network system, according to example embodiments.

FIG. 2 is a block diagram of the network system for providing transportation services involving contextual confirmation cards, according to example embodiments

FIG. 3 is a flowchart illustrating a method for providing transportation services involving contextual confirmation card, according to example embodiments.

FIG. 4 is a flowchart illustrating a method for determining content to provide in the contextual confirmation card, according to example embodiments.

FIG. 5 is a flowchart illustrating a method for training a machine learning model used to determine probability of acceptance or rejection of a transportation service, according to example embodiments.

FIG. 6A and FIG. 6B illustrate contextual confirmation cards presented to users new to autonomous vehicles (AVs), according to example embodiments.

FIG. 7 illustrates a contextual confirmation card presented to mid-probability users that have used AVs in the past, according to example embodiments.

FIG. 8A and FIG. 8B illustrate contextual confirmation cards presented to mid-probability users that have used AVs in the past in which a walk to a pickup point exceeds a threshold, according to example embodiments.

FIG. 9 is a block diagram illustrating components of a machine, according to some example implementations, able to read instructions from a machine-storage medium and perform any one or more of the methodologies discussed herein.

### DESCRIPTION

The description that follows describes systems, methods, techniques, instruction sequences, and computing machine program products that illustrate example implementations of the present subject matter. In the following description, for purposes of explanation, numerous specific details are set forth in order to provide an understanding of various implementations of the present subject matter. It will be evident, however, to those skilled in the art, that implementations of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

In example embodiments, a network system receives requests for transportation services from one or more users. A transportation service may include transporting a payload, such as cargo and/or one or more passengers, from a service start location to a service end location. Examples of cargo can include food, packages, and/or the like. The network system matches received transportation service requests from users with vehicles from a mixed fleet. The mixed fleet can include human-driven vehicles, autonomous vehicles (AVs), taxis, and/or motorcycles and can comprised different characteristics (e.g., number of seats, designated pickup and drop-off points). When a user accepts the matched transportation service, the network system can instruct the vehicle to begin executing the requested transportation service. In the case of AVs, the network system causes the AVs to travel to a pickup point associated with the transportation service request.

Example embodiments described herein are directed to systems and methods that provide transportation service that involves providing contextual confirmation cards. These contextual confirmation cards are graphical interfaces that present contextual information related to a matched transportation service being offered to a user. The matched transportation service comprise one or more characteristics, which may have an impact on whether the user will consent to at least one of the one or more characteristics and accept the transportation service being offered. The one or more characteristics can include one or more of, for example, a type of vehicle (e.g., an autonomous vehicle, a motorcycle, a bus), a number of seats in the vehicle, a long walk to a pickup point, a difficult walk to the pickup point, a long walk from a drop-off point to a destination of the request, or a difficult walk from a drop-off point to a destination of the request.

Based in part on the one or more characteristics, a probability that the user will accept or reject the transportation service is determined. In some embodiments, the probability is determined using machine learning. In other embodiments, the probability can be determined based on heuristics. Based on the probability, content that comprises contextual information regarding the transportation service is determined and caused to be presented in one or more graphical interfaces (also referred to herein as “contextual confirmation cards”). The content includes a request to accept the transportation service and, in some cases, can include a walking map to guide the user to a pickup point for the transportation service.

There is a balance between providing adequate contextual information and providing too much information or too many graphical interfaces in obtaining user consent for the transportation service. If a user has to scroll through multiple graphical interfaces to accept the transportation service, the user may abandon the request and find alternate transportation service. However, if the user is new or unfamiliar with one or more characteristics of the transportation service that is being offered, the user may need more contextual information in order to feel comfortable accepting the transportation service.

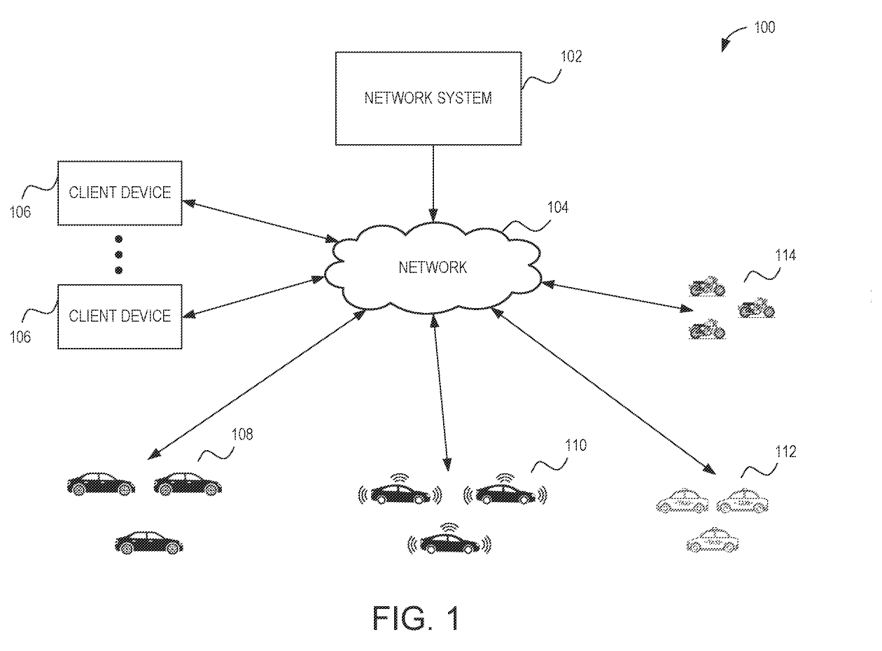

FIG. 1 is a diagram illustrating a network environment 100 suitable for providing transportation services by a network system 102, according to example embodiments. The network system 102 manages and/or assigns transportation service requests to a mixed fleet of vehicles. The environment 100 includes the network system 102 coupled via a network 104 to a plurality of client devices 106 and a fleet of vehicles. The fleet of vehicles can include one or more human-driven vehicles 108, one or more AVs 110, one or more taxis 112, and/or one or more motorcycles 114. Some of the vehicles may be passenger vehicles, such as passenger trucks, cars, buses, or other similar vehicles. Also, some of the vehicles may be delivery vehicles, such as vans, delivery trucks, tractor trailers, and so forth.

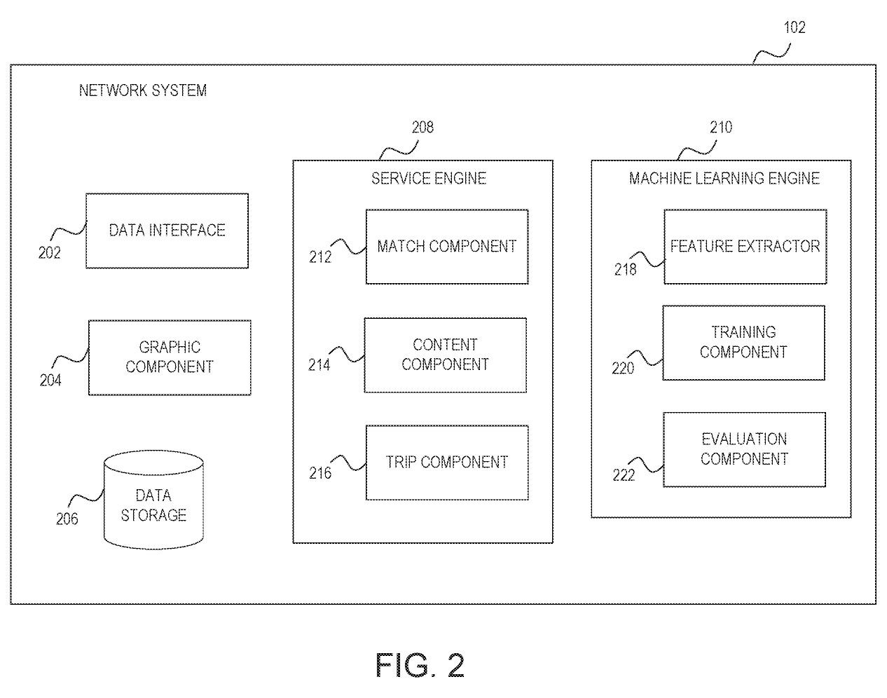

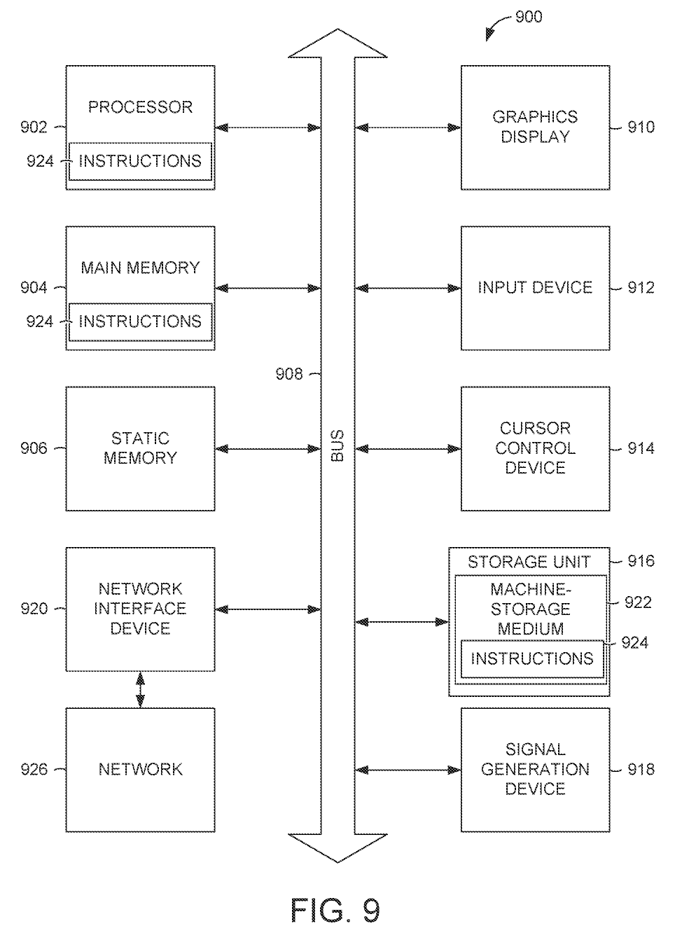

The network system 102 receives transportation service or trip requests from users via their respective client devices 106. The request can include, for example, an indication of a pickup point and a destination. The network system matches the request to a vehicle from the fleet of vehicles. The matched vehicle or transportation service has one or more characteristics (e.g., type of vehicle, number of seats in the vehicle, particular stopping locations) that can influence whether the user will accept the transportation service. In example embodiments, the network system 102 can determine a probability that the user will accept or reject the matched transportation service and can, in some cases, identify contextual content to provide to the user in an attempt to have the user confirm or consent to the transportation service. The components of the network system 102 are described in more detail in connection with FIG. 2 and may be implemented in a computer system, as described below with respect to FIG. 9.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example implementations, the client devices 106 are portable electronic devices such as smartphones, tablet devices, wearable computing devices (e.g., smartwatches), or similar devices. The client devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The client devices 106 interact with the network system 102 through a client application stored thereon. The client application of each client device 106 allows for exchange of information with the network system 102 via user interfaces, as well as in background. For example, the client application running on the client device 106 may determine and/or provide location information (e.g., current location in latitude and longitude) and times (e.g., timestamps) associated with portions of a transportation service, via the network 104, for storage and analysis.

In example implementations, a user (e.g., a rider) operates the client device 106 that executes the client application to communicate with the network system 102 to make a request for a transportation service (also referred to herein as a “trip”). In some implementations, the client application determines or allows the user to specify/select a pickup point or origin and to specify a drop-off location or destination for the trip. The client application also presents information, from the network system 102 via graphical interfaces, to the user of the client device 106. For instance, the graphical interface can display contextual information associated with trip and/or a walking map to a pickup location (e.g., if the pickup location is not a current location of the user).

In example embodiments, the AVs 110 include respective vehicle autonomy systems. The vehicle autonomy systems are configured to operate some or all of the controls of the AVs 110 (e.g., acceleration, braking, steering). In some examples, one or more of the AVs are operable in different modes, where the vehicle autonomy system has differing levels of control over the AV 110. Some AVs 110 may be operable in a fully autonomous mode in which the vehicle autonomy system has responsibility for all or most of the controls of the AV 110. Some AVs 110 are operable in a semiautonomous mode that is in addition to, or instead of, the fully autonomous mode. In a semiautonomous mode, the vehicle autonomy system of an AV 110 is responsible for some of the vehicle controls while a human user or driver is responsible for other vehicle controls. In some examples, one or more of the AVs 110 are operable in a manual mode in which the human user is responsible for all controls of the AV 110.

In some examples, the AVs 110 are of different types. Different types of AVs 110 may have different capabilities. For example, the different types of AVs 110 can have different vehicle autonomy systems. This can include, for example, vehicle autonomy systems made by different manufacturers or designers, vehicle autonomy systems having different software versions or revisions, and so forth. Also, in some examples, the different types of AVs 110 can have different remote-detection sensor sets. For example, one type of AV 110 may include a LIDAR remote-detection sensor, while another type may include stereoscopic cameras and omit a LIDAR remote-detection sensor. In some examples, different types of AVs 110 can also have different mechanical particulars. For example, one type of AVs may have all-wheel drive, while another type may have front-wheel drive, etc.

In some embodiments, the network system 102 communicates directly with the AVs 110. In other embodiments, the AVs 110 may be controlled by a third party and communications can be through a third-party system (e.g., via an application programming interface (API) call). For example, the network system 102 may provide transportation service offers to and receive replies directly from the AVs 110.

In the example of FIG. 1, the network system 102 also communicates with human-driven vehicles 108, for example, to provide transportation service offers and receive replies. The network system 102 may communicate with the vehicles 108 themselves (e.g., through an infotainment system or other suitable computing system of the vehicle) and/or with one or more human drivers of the vehicles 108 (e.g., via a user computing device or devices of the human drivers). It will be appreciated that FIG. 1 shows just one example of a mixed fleet and that different mixed fleets may have different numbers and proportions of AVs and human-driven vehicles along with taxis and/or motorcycles that are also available for transportation services.

The network system 102 is configured to receive and process transportation service requests from the users via their client devices 106. Upon receiving a transportation service request, the network system 102 may filter the fleet of vehicles to select a set of one or more candidate vehicles. The candidate vehicles may include vehicles that are suitable, or potentially suitable, for executing the requested transportation service. From the set of candidate vehicles, the network system 102 may select a vehicle or vehicles to which the requested transportation service will be offered. The network system 102 may select the vehicle or vehicles based on any suitable criterion or criteria such as, for example, vehicle locations, vehicle cost to execute the requested transportation service, a prior acceptance rate of the vehicle and/or of vehicles of the same type, and so forth. In some examples, the network system 102 selects a vehicle or vehicles to offer a transportation service using a route for the transportation service, which may be generated by the network system 102. The network system 102 may select the candidate vehicles based on various criteria such as, for example, the availability of the various vehicles in the fleet, properties of the request, user preferences, and/or the like. Properties of the request may include, for example, the trip start location, the trip end location, and a type of payload (e.g., size and weight of payload, number of passengers).

The example environment 100 describes a mixed fleet including AVs 110, human-driven vehicles 108, taxis 112, and motorcycles 114. It will be appreciated, however, that in various embodiments, the environment 100 may include more or fewer different types of vehicles. Additionally, any number of client devices 106 may be embodied within the network environment 100. While only a single network system 102 is shown, alternative embodiments may contemplate having more than one network system 102 (e.g., for different regions) to perform server operations discussed herein for the network system 102.

FIG. 2 is a block diagram of the network system 102 for providing transportation services involving contextual confirmation cards, according to example embodiments. In various embodiments, the network system 102 matches a trip request to a vehicle or transportation service. The transportation service comprises one or more characteristic that may or may not be different from what user expected. For example, the user may expect to be matched with a human-driven vehicle and, instead, is matched with an autonomous vehicle (AV). In these cases, the network system 102 determines contextual content to provide to the user. The contextual content can be different for different users based, in part, on their trip history with the network system 102. The contextual content is then presented in one or more graphical interfaces or cards on the client device 106. Should the user accept the trip (e.g., confirm or consent to the transportation service), the network system 102 establishes the trip.

To enable these operations, the network system 102 comprises a data interface 202, a graphic component 204, a data storage 206, a service engine 208, and a machine learning engine 210 all configured to communicate with each other (e.g., via a bus, shared memory, or a switch). The network system 102 can also comprise other components (not shown) that are not pertinent to example embodiments. Furthermore, any one or more of the components (e.g., engines, interfaces, components, storage) described herein can be implemented using hardware (e.g., a processor of a machine) or a combination of hardware and software. Moreover, any two or more of these components can be combined into a single component, and the functions described herein for a single component may be subdivided among multiple components.

The data interface 202 is configured to exchange data with the client devices 106 and cause presentation of one or more graphic interfaces generated by the graphic component 204 on the client devices 106 (e.g., via the client application) including graphical interfaces to request a transportation service and present contextual content. In example embodiments, the data interface 202 configures the client application on the client device 106 to display the graphical interfaces. In some cases, the data interface 202 also receives/accesses trip data from the client devices 106 before, during, and after a trip. The trip data can include location information such as GPS traces (e.g., latitude and longitude with timestamp) and times (e.g., timestamps) associated with events that occur during each trip (e.g., item pickup time, courier walking time, item delivery time) along with trip characteristics (e.g., pickup point, drop-off point, destination, type of vehicle, distance, cost). The trip data can be stored to the data storage 206 by the data interface 202 for later analysis.

The graphic component 204 is configured to generate graphical interfaces. In some cases, the graphic component 204 generates and causes display of contextual content associated with one or more characteristics of a transportation service matched to the request that the user may or may not have expected and an invitation to consent to the one or more characteristics and accept the transportation service or ride. The one or more characteristics can be, for example, a type of vehicle (e.g., an AV), a long or difficult walk to a pickup point, a long or difficult walk to a destination from a drop-off point, or a number of seats. In some cases, the graphic component 204 also includes consent requests for other issues. For example, consent may be requested to be recorded. Essentially, a consent request can be generated and displayed for anything that is different from what the user was expecting.

The data storage 206 is configured to store information associated with each user of the network system 102 including corresponding trip data. The trip data can include, for example, timestamps associated with each trip, events that occurred during each trip (e.g., pickups, drop-offs), coordinates associated with the trip (e.g., pickup locations, drop-off locations), type of vehicle providing the transportation service, distance, and/or cost. The stored information can also include user data including preferences, payment information, contact information, and/or transportation service offers accepted and rejected (e.g., user did not accept/consent to a transportation service that may have had different characteristic(s) than what they requested). In some implementations, the stored information is stored in or associated with a user profile corresponding to each user and includes a history of interactions using the network system 102.

The service engine 208 manages aspects of the transportation service including matching a request to a transportation service provider (e.g., a vehicle from the fleet), determining contextual content to provide in cases where the transportation service has one or more characteristics the user was not expecting (e.g., different vehicle type), obtaining any other consents that may be needed to establish a trip, and establishing the trip. To enable these operations, the service engine 208 comprises a match component 212, a content component 214, and a trip component 216. The service engine 208 may comprise other components (not shown) that are not pertinent to example implementations.

The match component 212 is configured to match the request to a transportation service (e.g., to one or more available vehicles from the fleet). The match can be based on criteria such as, being the closest to a requested pickup point, having the space capacity requested (e.g., request indicates a vehicle with at least six seats), providing the transportation service at the lowest cost, and so forth. In some cases, the match is for transportation service that comprises one or more characteristics that the user may not expect (e.g., different type of vehicle, difficult walk to a pickup point or from drop-off to destination). In other cases, the one or more characteristics are expected by the user. In either case, the match component 212 can trigger a determination for a probability that the user will accept or reject the matched transportation service. In some embodiments, the match component 212 triggers the machine learning engine 210 to determine the probability. In other embodiments, the match component can use heuristics to determine a probability.

Based on the probability, the match component 212 can determine whether to present the matched transportation service to the user. If the probability is extremely low (e.g., between 0 - 0.3), the match component 212 may not offer the matched transportation service and instead, performs another match to find another transportation service that the user is more likely to accept. However, if the probability is higher (e.g., greater than 0.3), the content component 214 can be triggered to determine contextual information to present to the user regarding the matched transportation service.

In example embodiments, the content component 214 is configured to determine the contextual information to present to the user in the graphical interfaces based on the probability. For example, for a very high probability (e.g., greater than 0.80), the content component 214 may determine that no additional contextual information is needed and to simply present the matched transportation service to the user for acceptance or rejection. This may occur when the one or more characteristics are not unexpected by the user or makes no difference to the user. In another example, for a mid-range probability (e.g., between 0.31 and 0.79), the content component 214 can provide one or more graphical interfaces of contextual information that can point out differences and/or benefits of the matched transportation service. In some embodiments, when the probability is higher (e.g., between 0.51 and 0.79), a single graphical interface can be provided, while a lower probability (e.g., between 0.31 and 0.5) may require more than one graphical interface to provide contextual information that may convince the user to accept the ride.

In embodiments where the user has never used a transportation service having the one or more characteristics (e.g., has never used an AV), the content component 214 can present contextual information that provides more information regarding the one or more characteristics. For example, if the user has never ridden in an AV and is now matched with one for the transportation service, the contextual information can include trust and safety information and information regarding what to expect when riding in the AV.

In some embodiments, the content component 214 can also determine whether to present a walking map to the pickup point as part of the contextual information for the matched transportation service. For example, if the matched transportation service is an AV or a public bus, the AV or public bus may only be able to stop in certain locations. These locations may not be at the user’s requested pickup point or destination. As such, the content component 214 can determine if a difference between the user’s requested pickup point and the pickup point for the matched transportation service is greater than a threshold. Similarly, the content component 214 can determine if a difference between the user’s requested destination and a drop-off point for the matched transportation service is greater than a threshold. For example, if the difference in distance is greater than 200 meters and/or if the time it will take to walk the difference is greater than two minutes, the content component 214 can include a walking map as additional contextual information in the graphical interfaces.

The trip component 216 is configured to establish a trip based on acceptance of the matched transportation service. The trip component 216 also generates and provides a route for the established trip. The route can be generated based on being the fastest, shortest, lowest cost, most fuel-efficient, based on preferences (e.g., avoid freeways, avoid hills, scenic route, frequently used route), based on routes frequently driven or selected by others of the network system 102, or selected by the network system 102 based on other reasons or criteria. In the case of AVs, the trip component 216 triggers the matched AV to travel to the pickup point of the request.

The machine learning engine 210 is configured to train and use one or more machine learning models that determine probabilities (e.g., probabilities that the user will accept or reject a matched transportation service). To enable these operations, the machine learning engine 210 comprises a feature extractor 218, a training component 220, and an evaluation component 222. In various embodiments, the machine learning engine 210 uses data from past trips and profile information (e.g., from the data storage 206) to train the machine learning models.

The feature extractor 218 extracts features that are used to train a machine learning model. In example embodiments, the feature extractor 218 accesses historical trip data and profile information from the trip data storage 206. The feature extractor 224 extracts features from the historical trip data and the profile information. The extracted features for each previous trip can include, for example, as how many trips having a particular characteristic has the user taken, how often does the user cancel trips having the particular characteristic, how often does the user cancel trips in general, what has the user rated trips having the particular characteristic, has the user had support requests or defects with trips having the particular characteristic, where is the trip taking place and a time of day, how long was an estimated time of arrival (ETA) for a trip having the particular characteristic to a pickup point, what was a walk distance of the pickup point, what was a walk distance of the drop-off location, what was a difference between the requested pickup point and actual pickup point, and/or how difficult was the walk.

The extracted features are provided to the training component 220, which uses the extracted features to train one or more machine learning models. In some embodiments, a machine learning model is trained to identify a probability that a user will accept (or reject) the matched transportation service. In some embodiments, a machine learning model can also be trained to identify contextual information (or level of contextual information) to provide to a user.

The evaluation component 222 is configured to apply extracted features associated with a user and the matched transportation service of a request identified by the match component 212 to the machine learning model trained by the training component 220. The matched transportation service may have a particular characteristic (e.g., it is an AV, it only seats two). The extracted features associated with the user can include how many trips having the particular characteristic the user has taken, how often has the user canceled trips having the particular characteristic, how often has the user canceled trips in general, what has the user rated trips having the particular characteristic in the past, and/or has the user had support requests or defects with trips having the particular characteristic. The extracted features associated with the matched transportation can include where is the trip taking place and time of day, how long is an estimated time of arrive of a vehicle for the trip, what is a walking distance to a pickup point, what is a walking distance from a drop-off point to a destination, what is a difference between a requested pickup point and an actual pickup point, and/or how difficult is the walk. With respect to the location and time of day, a 25-minute estimated time of arrival for vehicle pickup in the suburbs, for example may be acceptable because vehicles may not be near the user, but at 1pm in downtown, a 25-minute estimated time of arrival is bad. In some embodiments, the result will be a probability that the user will accept the matched transportation service. In other embodiments, the result will be a probability that the user will reject the matched transportation service. Additionally or alternatively, the result can indicate contextual information (or level of contextual information) to provide to the user.

As additional feedback (e.g., users accept or reject matches) and trip data is received, the additional feedback and trip data can be used to retrain the one or more machine learning models. As a result, the machine learning models can become more accurate/refined or change with changing conditions and trends (e.g., AV usage becomes more common in certain locales) – thus improving the accuracy of the network system 102. The training and retraining of the one or more machine learning models can occur at any time, during regular intervals (e.g., nightly, once a week), based on an event (e.g., when a certain amount of trip data is received), and/or be triggered manually.

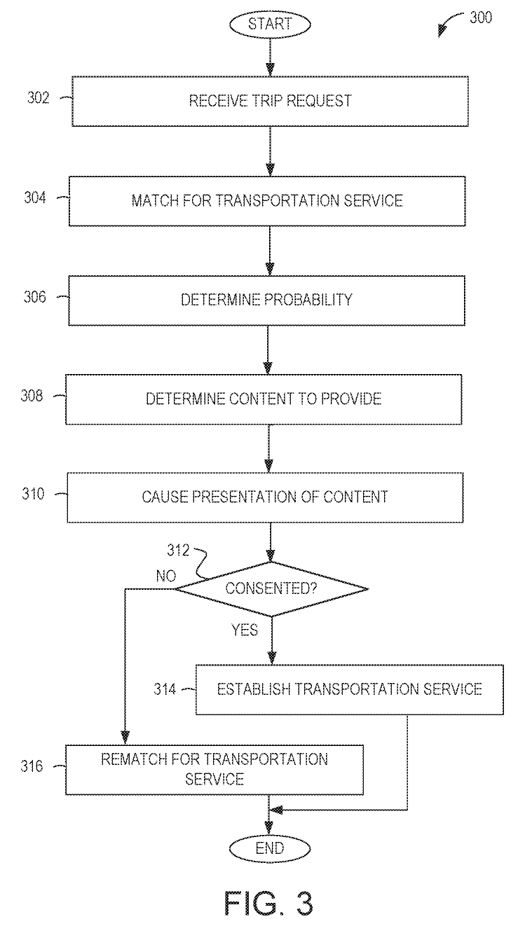

FIG. 3 is a flowchart illustrating a method 300 for providing transportation service involving contextual confirmation cards, according to example embodiments. Operations in the method 300 may be performed by the network system 102 as described above in part with respect to FIG. 2. Accordingly, the method 300 is described by way of example with reference to the network system 102. However, it shall be appreciated that at least some of the operations of the method 300 may be deployed on various other hardware configurations or be performed by similar components residing elsewhere in the environment 100. Therefore, the method 300 is not intended to be limited to the network system 102.

In operation 302, the network system 102 receives a transportation service request from a user of the client device 106. In example embodiments, the data interface 202 receives the transportation service request and transmits the information in the transportation service request to the service engine 208.

In operation 304, the service engine 208 matches the transportation service request to a transportation service. The match can be based on criteria such as, being the closest (e.g., in time or distance) to a requested pickup location, providing the transportation service at the lowest cost, and so forth. The matched transportation service has one or more characteristics. The characteristics can include, for example, a type of vehicle, a number of seats, a long or difficult walk to a pickup point, a long or difficult walk from a drop-off point to a destination, and/or a long estimated time of arrival at the pickup point.

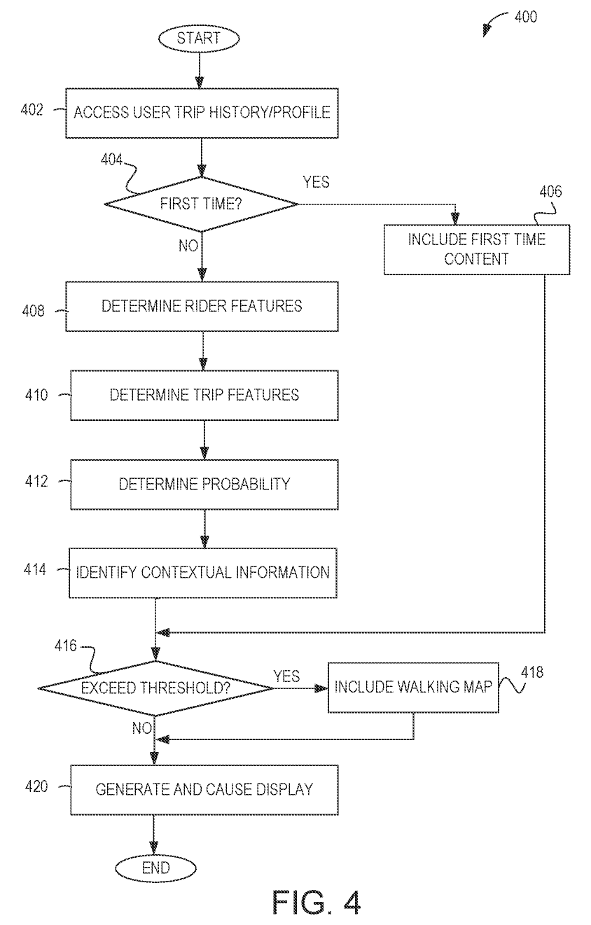

In operation 306, a probability of the user accepting or rejecting the matched transportation service is determined. Based on the probability, content to be provided to the user is determined in operation 308. Operation 306 and 308 will be discussed in more detail in connection with FIG. 4.

The determined contextual content that is determined in operation 308 can then be presented in operation 310. Accordingly, the content component 214 works with the graphic component 204 to generate one or more graphical interfaces or confirmation cards that are then displayed on the client device 106.

In operation 312, a determination is made whether the user accepted (e.g., consented) or rejected the matched transportation service. If the user accepted the matched transportation service, the transportation service or trip is established in operation 314. However, if the user rejected the matched transportation service, the network system 102 performs a rematch for transportation service in operation 316.

FIG. 4 is a flowchart illustrating a method 400 for determining content to provide in the contextual confirmation card (e.g. operation 308), according to example embodiments. Operations in the method 400 may be performed by the network system 102 as described above in part with respect to FIG. 2. Accordingly, the method 400 is described by way of example with reference to the network system 102. However, it shall be appreciated that at least some of the operations of the method 400 may be deployed on various other hardware configurations or be performed by similar components residing elsewhere in the environment 100. Therefore, the method 400 is not intended to be limited to the network system 102.

In operation 402, the service engine 208 and/or the machine learning engine 210 accesses trip history and profile information of the user. In example embodiments, the trip history and profile information can be accessed from the data storage 206.

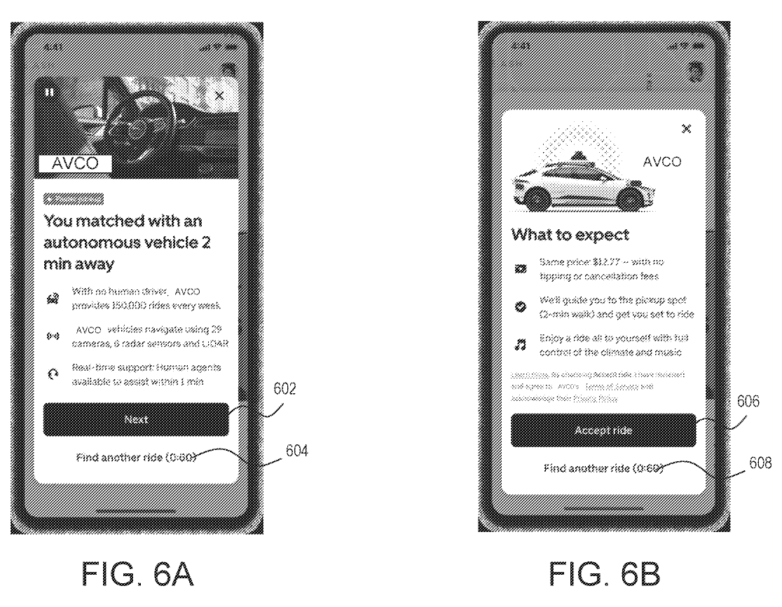

In operation 404, a determination is made whether this is the first time the user is matched with the transportation service having the one or more characteristics. In example embodiments, the content component 214 analyzes the trip history and profile information to make the determination. If it is the first time, then the content component 214 includes contextual content specifically for the first time, in operation 406. An example of contextual content for a first time offer of an AV transportation service (e.g., the characteristic is that the vehicle is an AV) is shown in FIG. 6A and FIG. 6B below.

If it is not the user’s first time, then in operation 408, the feature extractor 218 determines rider features. In example embodiment, the feature extractor 218 extracts the rider features from the trip history and profile information of the user. The rider features can include, for example, how many trips has the user taken with a transportation service having a particular characteristic, how often does the user canceled a transportation service having the particular characteristic, how often has the user canceled trips in general, what has the user rated transportation services having the particular characteristic, and/or has the user had support requests or defects with transportation services having the particular characteristic. In one embodiment, the particular characteristic is that a vehicle providing the transportation service is an AV.

In operation 410, the feature extractor 218 determines trip features associated with the matched transportation service. The trip features can include, for example, where is the trip taking place and time of day, how long is an estimated time of arrive for a vehicle of the matched transportation service to the pickup point, what is a walking distance to the pickup point, what is a walking distance from a drop-off point to a destination, what is the difference between a requested pickup point in the request and an actual pickup point of the vehicle, and/or how difficult is the walk to the pickup point or destination. In some cases, the vehicle of the matched transportation service may not be able to stop at the requested pickup point or destination. This can be the case when the vehicle is an AV, which has designations areas where it may stop. Thus, factors such as the estimated time of arrive to the pickup point, walking distance, and walking difficulty between the requested and actual pickup points or destinations should be considered.

In operation 412, the evaluation component 222 determines a probability that the user will accept (or reject) the matched transportation service. In example embodiments, the rider and trip features extracted in operations 408 and 410 are applied to the machine learning model which predicts a likelihood of whether the user will accept or reject the matched transportation service. In other embodiments, heuristics can be used to predict the likelihood.

In operation 414, the content component 214 identifies contextual information to present based on the probability. For example, a very high probability (e.g., greater than 0.85) may result in no additional contextual information being needed. Because the user may have taken many trips having the one or more characteristics or has agreed to take trips having the one or more characteristics at least a threshold number of time (e.g., more than 20 times), there is no need to provide additional contextual information regarding the one or more characteristics. As such, the content component 214 can simply present the matched transportation service to the user for acceptance or rejection. In another example, if a mid-range probability (e.g., between 0.41 and 0.74) is returned, the content component 214 can provide contextual information that can point out differences and/or benefits of the matched transportation service. For example, the estimated time of arrive (ETA) for an AV to the pickup point can be provided if the ETA is longer than expected (e.g., versus a different type of vehicle).

In operation 416, a determination is made whether a change in a pickup location (or a drop-off location) exceeds a threshold. For example, if the matched transportation service involves an AV or for a public bus, the AV or public bus may only be able to stop in certain locations. These locations may not be the same as the user’s requested pickup point or destination. As such, the content component 214 can determine if the difference between the user’s requested pickup point and a pickup point for the matched transportation service is greater than a threshold and/or if the difference between the user’s requested destination and a drop-off point for the matched transportation service is greater than the threshold. The threshold can be a distance threshold (e.g., greater than 200 meters) or the threshold can be a time threshold (e.g., greater than two minutes). If the distance or time threshold is exceeded, then the content component 214 can include a walking map as part of the contextual information in operation 418. If the threshold is not exceeded or if there is no change in the pickup or drop-off location (e.g., the change is zero), only the contextual information identified in operation 414 is included.

In operation 420, the graphic component 204 generates the graphical interface(s). The graphical component 204 includes any contextual content identified in operations 406, 414, and/or 418 in generating the graphical interface(s). The graphical interface(s) are then caused to be displayed on the client device of the user. In some cases, the data interface transmits the graphical interface(s) to the client device.

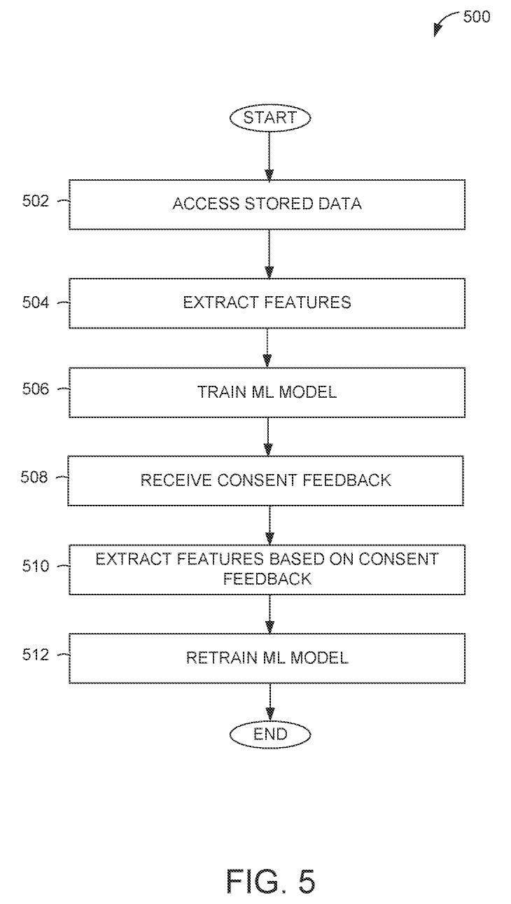

FIG. 5 is a flowchart illustrating a method 500 for training a machine learning (ML) model used to determine probabilities of acceptance or rejection of a matched transportation service, according to example embodiments. Operations in the method 500 may be performed by the network system 102 (e.g., the machine learning engine 210) as described above in part with respect to FIG. 2. Accordingly, the method 500 is described by way of example with reference to the network system 102. However, it shall be appreciated that at least some of the operations of the method 500 may be deployed on various other hardware configurations or be performed by similar components residing elsewhere in the environment 100. Therefore, the method 500 is not intended to be limited to the network system 102.

In operation 502, the machine learning engine 210 accesses stored trip data and profile information for a plurality of users (collectively referred to as “accessed data”). The accessed data can be accessed from the data storage 206. In some cases, the accessed data is accessed for a certain time period (e.g., the last year) for training purposes. In some cases, the accessed data can be grouped, for example, by mode of transportation service provided, location or region, time of day, type of user, or any other criteria.

In operation 504, the feature extractor 218 extracts features from the accessed data that will be used to train the ML model. In some embodiments, the extracted features for each previous trip from the accessed data can include, for example, as how many trips has a user (of each previous trip) taken, how often does the user cancel trips having a particular characteristic, how often does the user cancel trips in general, what has the user rated trips having the particular characteristic, has the user had support requests or defects with trips having the particular characteristics, where did the trip take place and time of day, how long was an estimated time of arrival for a vehicle to arrival to a pickup point, what was a walking distance to the pickup point, what was the walking distance from a drop-off point to a destination, what was a difference between the requested pickup point and an actual pickup point, and/or how difficult was the walk.

In operation 506, the training component 220 trains the ML model. In example embodiments, the training component 220 generates vector representations based on the extracted features. The ML model is then trained based on the generated vector representations. The training of the ML model may include training for probabilities (e.g., thresholds and/or ranges) of whether a user will accept or reject a transportation service having a particular characteristic(s). The machine training can occur using, for example, linear regression, logistic regression, a decision tree, an artificial neural network, k-nearest neighbors, and/or k-means.

In operation 508, the network system 102 receives consent feedback from one or more client devices. The consent feedback can be an acceptance or rejection of a matched transportation service. The consent feedback can be stored to the data storage 206 along with any trip details. In the case where the user consented/accepted the matched transportation service, the consent feedback can be stored as part of the trip history and/or the user profile. In the case where the user rejected the matched transportation service, the consent feedback can be stored as part of the user profile.

In operation 510, the feature extractor 218 extracts features based on the consent feedback for use in retraining the ML model. This retraining can occur at a regular period of time (e.g., every three months), when a certain amount of consent feedback or new trip data has been stored, or be manually triggered by an operator associated with the network system 102. The extracted features can, in some embodiments, be used to generate vector representations.

In operation 512, the training component 220 retrains the ML model using the extracted featured from the consent feedback. In some embodiments, the ML model is trained using the generated vector representations of these extracted features.

FIG. 6A and FIG. 6B illustrate contextual confirmation cards presented to users new to autonomous vehicles (AVs), according to example embodiments. In embodiments where the matched transportation service is with an AV, the content component 214 can detect if the user has ever used an AV transportation service. If the user has never used an AV transportation service, then the content component 214 can present graphical interfaces such as those shown in FIG. 6A and FIG. 6B. These graphical interfaces or contextual confirmation cards provide trust and safety information along with information on what to expect that may help convince the user to accept the AV transportation match.

Referring to FIG. 6A, the contextual content focuses on making sure the user understands the concept of an AV and does not reject it outright. As such, the graphical interface provides information about what the user matched with (e.g., an AV, no human drivers), is it safe (e.g., provides 150,000 rides every week; navigates using 29 cameras, 6 radar sensors, and LIDAR), and what if there is a problem (e.g., real-time support with human agents available). If the user is still interested in using the AV transportation service, the user can select a next icon 602. However, if the user does not want to ride with the AV, the user can reject the match (e.g., select a “find another ride” icon 604).

If the user selects the next icon 602, the user is presented with a second graphical interface shown in FIG. 6B. The second graphical interface provides information about what to expect from the trip and what the experience may be like. For example, the user does not need to tip, and the price is the same as with a human-driven vehicle. Additionally, the user has full control of climate and music in the AV. Further still, the user can be guided to a pickup point of the AV. In the present case, there is no walking map presented prior to acceptance of the AV transportation service match. Instead, the graphical interface of FIG. 6B can transition to an enroute screen that displays a walking map to the AV pickup point.

Should the user agree to the AV transportation service match, the user can select an accept icon (e.g., “accept ride” icon 606). However, if the user does not want to ride in the AV, the user can reject the match (e.g., select a “find another ride” icon 608).

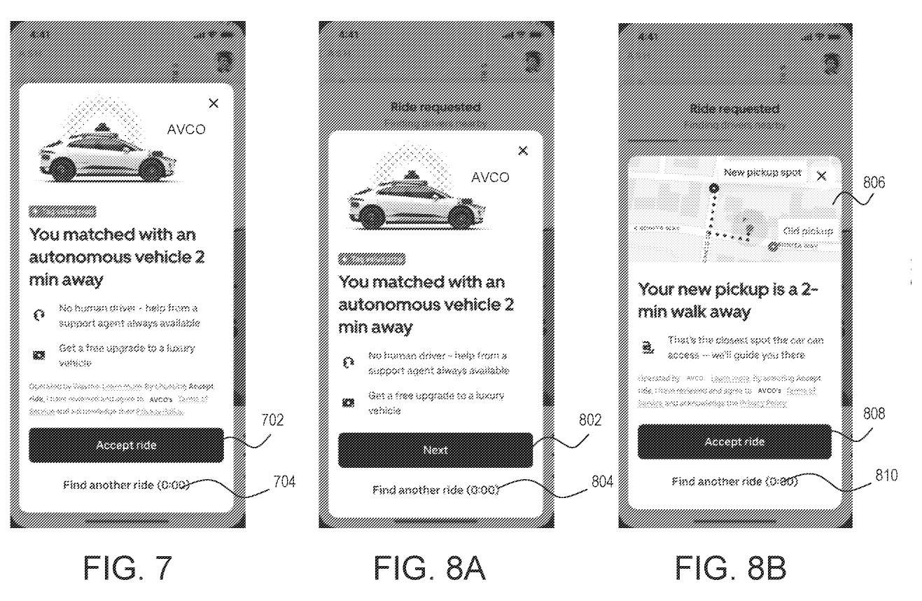

FIG. 7 illustrates a contextual confirmation card presented to mid-range probability users that have likely used AVs in the past, according to example embodiments. Because these users have ridden in an AV before, less contextual content is needed. Thus, only a single graphical interface with less contextual information can be presented to these users. For example, the single graphical interface shown in FIG. 7 only includes an indication that there is no human driver and that support is available. The graphical interface also indicates that the user is getting a free upgrade to a luxury vehicle, although other contextual information could be provided (e.g., same price as a human-driven vehicle, no tipping needed). In some cases, if the ETA of the AV to the pickup point is longer than expected, the graphical interface can include content mentioning that the ETA is longer and the reason why (e.g., the AV can only stop at particular locations). The graphical interface of FIG. 7 includes an icon to accept the ride 702 and an icon to reject the ride 704 (e.g., find another ride).

FIG. 8A and FIG. 8B illustrate contextual confirmation cards presented to mid-range probability users in which a walk to a pickup point exceeds a threshold, according to example embodiments. In this example, FIG. 8A provides similar contextual information as the graphical interface of FIG. 7. However, because the walk exceeds a distance threshold or time threshold, a walking map can be provided to provide additional context for the match. As such, instead of the accept icon 702 shown in FIG. 7, a next icon 802 is presented on the graphical interface that will cause presentation of a second graphical interface. The graphical interface of FIG. 8A also includes an icon to reject the match 804 (e.g., find another ride).

Selection of the next icon 802 causes presentation of a second graphical interface as shown in FIG. 8B. The second graphical interface includes a walking map 806 and contextual information regarding why a walk to a new pickup point (e.g., an AV pickup point) is needed. In some cases, because the AV can only stop at certain pickup points, the AV pickup point can be different from a requested pickup point in the request (e.g., an old pickup-point). The second graphical interface displays the new pickup point, the old pickup point, and guidance (e.g., a dotted line) to walk from the old pickup point to the new pickup point. Given this additional contextual information, the user can accept the ride by selecting an accept icon 808 or reject the ride by selecting a reject icon 810 (e.g., find another ride).

While the example graphical interfaces of FIG. 6 through FIG. 8B involved a characteristic of the transportation service being the vehicle is an AV, example embodiments can be used to present contextual information for other characteristics. For example, if the characteristic of the transportation service is that the walk to the pickup point is difficult, a graphical interface can be displayed to the user providing information regarding the difficult walk, possibly showing a walking map, and requesting the user consent to the difficult walk (e.g., accept the transportation service). As another example, if the characteristic of the transportation service is that the ride is recorded, a graphical interface can be displayed that provides information regarding recording the ride (e.g., done for the driver or your safety) and a request to consent to being recorded.

FIG. 9 illustrates components of a machine 900, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 9 shows a diagrammatic representation of the machine 900 in the example form of a computer device (e.g., a computer) and within which instructions 924 (e.g., software, a program, an application, an applet, an app, or other executable code) for causing the machine 900 to perform any one or more of the methodologies discussed herein may be executed, in whole or in part.

For example, the instructions 924 may cause the machine 900 to execute the flow diagrams of FIG. 3 through and FIG. 5. In one implementation, the instructions 924 can transform the machine 900 into a particular machine (e.g., specially configured machine) programmed to carry out the described and illustrated functions in the manner described.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924 (sequentially or otherwise) that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more components described herein.

The machine 900 may further include a graphics display 910 (e.g., a plasma display panel (PDP), a light emitting diode (LED) display, a liquid crystal display (LCD), a projector, or a cathode ray tube (CRT), or any other display capable of displaying graphics or video). The machine 900 may also include an input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a sound card, an amplifier, a speaker, a headphone jack, or any suitable combination thereof), and a network interface device 920.

The storage unit 916 includes a machine-storage medium 922 (e.g., a tangible machine-storage medium) on which is stored the instructions 924 (e.g., software) embodying any one or more of the methodologies or functions described herein. The instructions 924 may also reside, completely or at least partially, within the main memory 904, within the processor 902 (e.g., within the processor’s cache memory), or both, before or during execution thereof by the machine 900. Accordingly, the main memory 904 and the processor 902 may be considered as machine-storage media (e.g., tangible and non-transitory machine-storage media). The instructions 924 may be transmitted or received over a network 926 via the network interface device 920.

In some example implementations, the machine 900 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 904, 906, and/or memory of the processor(s) 902) and/or storage unit 916 may store one or more sets of instructions and data structures (e.g., software) 924 embodying or utilized by any one or more of the methodologies or functions described herein. These instructions, when executed by processor(s) 902 cause various operations to implement the disclosed implementations.

As used herein, the terms “machine-storage medium,” “device-storage medium,” “computer-storage medium” (referred to collectively as “machine-storage medium 922”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 may further be transmitted or received over a communications network 926 using a transmission medium via the network interface device 920 and utilizing any one of a number of well-known transfer protocols (e.g., HTTP). Examples of communication networks 926 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 924 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

"Component" refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### Examples

Example 1 is a method for providing contextual confirmation cards for a transportation service. The method comprises receiving a transportation service request from a first user; determining a match of the transportation service request to a transportation service, the transportation service having one or more characteristics; based at least in part on the one or more characteristics of the transportation service, determining a probability that the first user will reject the transportation service; based in part on the probability, determining content to present in one or more graphical interfaces to the first user, the content inviting the first user to consent to at least one of the one or more characteristics of the transportation service; causing presentation of the content in the one or more graphical interfaces on a device of the first user, the content including a request to accept the transportation service and a description of at least the one of the one or more characteristics of the transportation service; receiving an indication that the first user has accepted the transportation service; and responsive to the indication that the first user has accepted the transportation service, causing a vehicle to begin executing the transportation service requested by the first user.

In example 2, the subject matter of example 1 can optionally include wherein the vehicle comprises an autonomous vehicle (AV); and causing the vehicle to begin executing the transportation service comprise causing the AV to travel to a pickup location associated with the transportation service.

In example 3, the subject matter of any of examples 1-2 can optionally include wherein causing presentation of the content comprises causing presentation of a first graphical interface of the one or more graphical interface that displays contextual information regarding the transportation service and a next icon; and in response to a selection of the next icon, causing presentation of a second graphical interface that display additional contextual information regarding the transportation service and an icon to accept the transportation service.

In example 4, the subject matter of any of examples 1-3 can optionally include wherein determining the probability comprises accessing a trip history associated with the first user; and applying features of the trip history and trip features of the transportation service to a machine-learning (ML) model that predicts the probability.

In example 5, the subject matter of any of examples 1-4 can optionally include wherein the features of the trip history comprises one or more of how many trips having the one or more characteristics of the transportation service has the first user taken, how often does the first user cancel trips having the one or more characteristics of the transportation service, how often does the first user cancel trips in general, what has the first user rated trips having the one or more characteristics of the transportation service in the past, or has the first user had support requests or defects with past trips having the one or more characteristics of the transportation service.

In example 6, the subject matter of any of examples 1-5 can optionally include wherein the trip features of the transportation service comprises one or more of where is the trip taking place and time of day, how long is an estimated time of arrival of the vehicle of the transportation service to a pickup point, what is a walking distance to the pickup point, what is a walking distance from a drop-off point to the destination, what is the difference between a requested pickup point and the pickup point, or how difficult is a walk to the pickup point.

In example 7, the subject matter of any of examples 1-6 can optionally include training a machine learning (ML) model to predict the probability; receiving indications from a plurality of users of acceptance or rejection of transportation service having different characteristics, including the indication that the first user has accepted the transportation service; and retraining the ML model based on the indications from the plurality of user.

In example 8, the subject matter of any of examples 1-7 can optionally include receiving a second transportation service request from a second user; determining a match of the second transportation service to a second transportation service, the second transportation service having one or more characteristics; in response to the matching, accessing a trip history associated with the second user; determining, based on the trip history associated with the second user, that the second user has never used a transportation service having the one or more characteristics of the second transportation service, and based on the determining that the second user has never used the transportation service having the one or more characteristics of the second transportation service, causing presentation of trust and safety content along with a request to accept the second transportation service in one or more graphical interfaces on a device of the second user.

In example 9, the subject matter of any of examples 1-8 can optionally include determining that a walk to a pickup point of the transportation service exceeds a time or distance threshold, wherein the content presented in one or more graphical interfaces includes a walking map to the pickup point.

In example 10, the subject matter of any of examples 1-9 can optionally include wherein the one or more graphical interfaces further comprises an icon to reject of the transportation service by requesting to find a different transportation service.

In example 11, the subject matter of any of examples 1-10 can optionally include wherein the one or more characteristics comprises one or more of a type of vehicle, a number of seats, a long walk to pickup point, a difficult walk to the pickup point, or a long walk from a drop-off point to a destination of the request.

Example 12 is a system for providing contextual confirmation cards for a transportation service. The system comprises one or more processors and a memory storing instructions that, when executed by the one or more processors, cause the one or more processors to perform operations comprising receiving a transportation service request from a first user; determining a match of the transportation service request to a transportation service, the transportation service having one or more characteristics; based at least in part on the one or more characteristics of the transportation service, determining a probability that the first user will reject the transportation service; based in part on the probability, determining content to present in one or more graphical interfaces to the first user, the content inviting the first user to consent to at least one of the one or more characteristics of the transportation service; causing presentation of the content in the one or more graphical interfaces on a device of the first user, the content including a request to accept the transportation service and a description of at least the one of the one or more characteristics of the transportation service; receiving an indication that the first user has accepted the transportation service; and responsive to the indication that the first user has accepted the transportation service, causing a vehicle to begin executing the transportation service requested by the first user.

In example 13, the subject matter of example 12 can optionally include wherein the vehicle comprises an autonomous vehicle (AV); and causing the vehicle to begin executing the transportation service comprise causing the AV to travel to a pickup location associated with the transportation service.

In example 14, the subject matter of any of examples 12-13 can include wherein causing presentation of the content comprises causing presentation of a first graphical interface of the one or more graphical interface that displays contextual information regarding the transportation service and a next icon; and in response to a selection of the next icon, causing presentation of a second graphical interface that display additional contextual information regarding the transportation service and an icon to accept the transportation service

In example 15, the subject matter of any of examples 12-14 can include wherein determining the probability comprises accessing a trip history associated with the first user; applying features of the trip history and trip features of the transportation service to a machine-learning (ML) model that predicts the probability.

In example 16, the subject matter of any of examples 12-15 can include wherein the operations further comprise training a machine learning (ML) model to predict the probability; receiving indications from a plurality of users of acceptance or rejection of transportation service having different characteristics, including the indication that the first user has accepted the transportation service; and retraining the ML model based on the indications from the plurality of user.

In example 17, the subject matter of any of examples 12-16 can include wherein the operations further comprise receiving a second transportation service request from a second user; determining a match of the second transportation service to a second transportation service, the second transportation service having one or more characteristics; in response to the matching, accessing a trip history associated with the second user; determining, based on the trip history associated with the second user, that the second user has never used a transportation service having the one or more characteristics of the second transportation service, and based on the determining that the second user has never used the transportation service having the one or more characteristics of the second transportation service, causing presentation of trust and safety content along with a request to accept the second transportation service in one or more graphical interfaces on a device of the second user

In example 18, the subject matter of any of examples 12-17 can optionally include wherein the operations further comprise determining that a walk to a pickup point of the transportation service exceeds a time or distance threshold, wherein the content presented in one or more graphical interfaces includes a walking map to the pickup point.

In example 19, the subject matter of any of examples 12-18 can optionally include wherein the one or more graphical interfaces further comprises an icon to reject of the transportation service by requesting to find a different transportation service.

Example 20 is a machine-storage medium comprising instructions which, when executed by one or more processors of a machine, cause the machine to perform operations for providing contextual confirmation cards for a transportation service. The operations comprise receiving a transportation service request from a first user; determining a match of the transportation service request to a transportation service, the transportation service having one or more characteristics; based at least in part on the one or more characteristics of the transportation service, determining a probability that the first user will reject the transportation service; based in part on the probability, determining content to present in one or more graphical interfaces to the first user, the content inviting the first user to consent to at least one of the one or more characteristics of the transportation service; causing presentation of the content in the one or more graphical interfaces on a device of the first user, the content including a request to accept the transportation service and a description of at least the one of the one or more characteristics of the transportation service; receiving an indication that the first user has accepted the transportation service; and responsive to the indication that the first user has accepted the transportation service, causing a vehicle to begin executing the transportation service requested by the first user.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

1. A method comprising:
receiving a transportation service request from a first user;
determining a match of the transportation service request to a transportation service, the transportation service having one or more characteristics;
based at least in part on the one or more characteristics of the transportation service, determining a probability that the first user will reject the transportation service;
based in part on the probability, determining content to present in one or more graphical interfaces to the first user, the content inviting the first user to consent to at least one of the one or more characteristics of the transportation service;
causing presentation of the content in the one or more graphical interfaces on a device of the first user, the content including a request to accept the transportation service and a description of at least the one of the one or more characteristics of the transportation service;
receiving an indication that the first user has accepted the transportation service; and
responsive to the indication that the first user has accepted the transportation service, causing a vehicle to begin executing the transportation service requested by the first user.

2. The method of claim 1, wherein:
the vehicle comprises an autonomous vehicle (AV); and
causing the vehicle to begin executing the transportation service comprise causing the AV to travel to a pickup location associated with the transportation service.

3. The method of clam 1, wherein causing presentation of the content comprises:
causing presentation of a first graphical interface of the one or more graphical interface that displays contextual information regarding the transportation service and a next icon; and
in response to a selection of the next icon, causing presentation of a second graphical interface that display additional contextual information regarding the transportation service and an icon to accept the transportation service.

4. The method of claim 1, wherein determining the probability comprises:
accessing a trip history associated with the first user; and
applying features of the trip history and trip features of the transportation service to a machine-learning (ML) model that predicts the probability.

5. The method of claim 4, wherein the features of the trip history comprises one or more of:
how many trips having the one or more characteristics of the transportation service has the first user taken,
how often does the first user cancel trips having the one or more characteristics of the transportation service,
how often does the first user cancel trips in general,
what has the first user rated trips having the one or more characteristics of the transportation service in the past, or
has the first user had support requests or defects with past trips having the one or more characteristics of the transportation service.

6. The method of claim 4, wherein the trip features of the transportation service comprises one or more of:
where is the trip taking place and time of day,
how long is an estimated time of arrival of the vehicle of the transportation service to a pickup point,
what is a walking distance to the pickup point,
what is a walking distance from a drop-off point to the destination,
what is the difference between a requested pickup point and the pickup point, or
how difficult is a walk to the pickup point.

7. The method of claim 1, further comprising:
training a machine learning (ML) model to predict the probability;
receiving indications from a plurality of users of acceptance or rejection of transportation service having different characteristics, including the indication that the first user has accepted the transportation service; and
retraining the ML model based on the indications from the plurality of user.

8. The method of claim 1, further comprising:
receiving a second transportation service request from a second user;
determining a match of the second transportation service to a second transportation service, the second transportation service having one or more characteristics;
in response to the matching, accessing a trip history associated with the second user;
determining, based on the trip history associated with the second user, that the second user has never used a transportation service having the one or more characteristics of the second transportation service, and
based on the determining that the second user has never used the transportation service having the one or more characteristics of the second transportation service, causing presentation of trust and safety content along with a request to accept the second transportation service in one or more graphical interfaces on a device of the second user.

9. The method of claim 1, further comprising:
determining that a walk to a pickup point of the transportation service exceeds a time or distance threshold, wherein the content presented in one or more graphical interfaces includes a walking map to the pickup point.

10. The method of claim 1, wherein the one or more graphical interfaces further comprises an icon to reject of the transportation service by requesting to find a different transportation service.

11. The method of claim 1, wherein the one or more characteristics comprises one or more of:
a type of vehicle,
a number of seats,
a long walk to pickup point,
a difficult walk to the pickup point, or
a long walk from a drop-off point to a destination of the request.

12. A system comprising:
one or more processors; and
a memory storing instructions that, when executed by the one or more processors, cause the one or more processors to perform operations comprising:
receiving a transportation service request from a first user;
determining a match of the transportation service request to a transportation service, the transportation service having one or more characteristics;
based at least in part on the one or more characteristics of the transportation service, determining a probability that the first user will reject the transportation service;
based in part on the probability, determining content to present in one or more graphical interfaces to the first user, the content inviting the first user to consent to at least one of the one or more characteristics of the transportation service;
causing presentation of the content in the one or more graphical interfaces on a device of the first user, the content including a request to accept the transportation service and a description of at least the one of the one or more characteristics of the transportation service;
receiving an indication that the first user has accepted the transportation service; and
responsive to the indication that the first user has accepted the transportation service, causing a vehicle to begin executing the transportation service requested by the first user.

13. The system of claim 12, wherein:
the vehicle comprises an autonomous vehicle (AV); and
causing the vehicle to begin executing the transportation service comprise causing the AV to travel to a pickup location associated with the transportation service.

14. The system of claim 12, wherein causing presentation of the content comprises:
causing presentation of a first graphical interface of the one or more graphical interface that displays contextual information regarding the transportation service and a next icon; and
in response to a selection of the next icon, causing presentation of a second graphical interface that display additional contextual information regarding the transportation service and an icon to accept the transportation service.

15. The system of claim 12, wherein determining the probability comprises:
accessing a trip history associated with the first user; and
applying features of the trip history and trip features of the transportation service to a machine-learning (ML) model that predicts the probability.

16. The system of claim 12, wherein the operations further comprise:
training a machine learning (ML) model to predict the probability;
receiving indications from a plurality of users of acceptance or rejection of transportation service having different characteristics, including the indication that the first user has accepted the transportation service; and
retraining the ML model based on the indications from the plurality of user.

17. The system of claim 12, wherein the operations further comprise:
receiving a second transportation service request from a second user;
determining a match of the second transportation service to a second transportation service, the second transportation service having one or more characteristics;
in response to the matching, accessing a trip history associated with the second user;
determining, based on the trip history associated with the second user, that the second user has never used a transportation service having the one or more characteristics of the second transportation service, and
based on the determining that the second user has never used the transportation service having the one or more characteristics of the second transportation service, causing presentation of trust and safety content along with a request to accept the second transportation service in one or more graphical interfaces on a device of the second user.

18. The system of claim 12, wherein the operations further comprise:
determining that a walk to a pickup point of the transportation service exceeds a time or distance threshold, wherein the content presented in one or more graphical interfaces includes a walking map to the pickup point.

19. The system of claim 12, wherein the one or more graphical interfaces further comprises an icon to reject of the transportation service by requesting to find a different transportation service.

20. A machine-storage medium comprising instructions which, when executed by one or more processors of a machine, cause the machine to perform operations comprising:
receiving a transportation service request from a first user;
determining a match of the transportation service request to a transportation service, the transportation service having one or more characteristics;
based at least in part on the one or more characteristics of the transportation service, determining a probability that the first user will reject the transportation service;
based in part on the probability, determining content to present in one or more graphical interfaces to the first user, the content inviting the first user to consent to at least one of the one or more characteristics of the transportation service;
causing presentation of the content in the one or more graphical interfaces on a device of the first user, the content including a request to accept the transportation service and a description of at least the one of the one or more characteristics of the transportation service;
receiving an indication that the first user has accepted the transportation service; and
responsive to the indication that the first user has accepted the transportation service, causing a vehicle to begin executing the transportation service requested by the first user.
